(19) United States
(12) Patent Application Publication
(10) Pub. No.: US 2006/0272227 A1
(43) Pub. Date: Dec. 7, 2006

(54) Transparent element, especially a composite glass element

(76) Inventor: Christoph Doeppner, EICHENZELL (DE)

Correspondence Address: FLYNN THIEL BOUTELL & TANIS, P.C., 2026 RAMBLING ROAD, KALAMAZOO, MI, 49008-1631, US

(21) Appl. No.: 10/548,607

(22) PCT Filed: Mar. 5, 2004
(86) PCT No.: PCT/EP04/02266

§ 371 Date: Sep. 6, 2005

(30) Foreign Application Priority Data
Mar. 7, 2003 (EP) 03005082.7

(51) Int. Cl. E06B 7/00

(52) U.S. Cl. 52/171.3

(57) ABSTRACT

The invention relates to a transparent element (6) comprising at least one transparent pane (20). At least one receiving element (5) in the form of an opening (11) can be provided in said transparent element, for at least one media consumer (7) which can be an illuminant (14), e.g. an LED, a loudspeaker, or another energy converter. The media supply for supplying or connecting the media consumer is integrated into the transparent element (6). Said media supply is preferably a current supply and, in the case of composite glass panes, is provided between the panes, for example, integrated into an insulating plastic layer or into a cast resin layer.

### FIELD OF APPLICATION AND PRIOR ART

The invention relates to a transparent element, which is in particular constructed as a composite glass element. The transparent element has at least one transparent pane.

Besides windows, there are numerous other fields of use for transparent elements, e.g. large-area glass fronts of buildings, shop windows, building roof elements, etc. In particular, modern architecture is greatly in favour of transparent elements in order to make buildings appear more lively.

It is known from EP 900971 A1 to fix light emitting diodes to a glass plate and which are supplied with power by means of thin, invisible conducting tracks. The diodes are fitted to the same glass plate surface on which the light emitting diodes are located.

EP 593940 A1 describes a composite glass pane with an incorporated wire, which is contacted from the pane rim, a plug contact being fitted to the glass surface.

U.S. Pat. No. 5,105,303 discloses a composite pane with an electrochromatic intermediate layer and U.S. Pat. No. 4,100,398 discloses a composite pane with an electric heater incorporated into the intermediate layer.

U.S. Pat. No. 5,533,289 describes an electroluminescent element incorporated between the panes and which is supplied with power from the pane rim or edge.

### PROBLEM AND SOLUTION

Therefore the problem of the invention is to provide a transparent element offering additional possibilities of use.

This problem is solved by a transparent element having the features of claim 1.

The transparent element according to the invention is characterized in that it has at least one receptacle for at least one media consumer. The media supply for the media consumer is integrated into the transparent element and the media supply e.g. passes between two panes. However, it is also conceivable to integrate the media supply into the pane material, e.g. to embed it therein.

The receptacle is preferably an opening in one of at least two interconnected panes between which passes the media supply, e.g. an electric conduction in the form of a transparent layer or a thin wire.

The transparent element is preferably of glass. However, it is also possible to use a transparent plastic, e.g. acrylic glass. The at least one pane of the transparent element is preferably planar or flat. However, it is also possible to use panes with curved areas.

Preferably the media consumer is an electric load and consequently the media supply is a power or current supply. The electric load can e.g. be constituted by a lighting device with one or more illuminants, e.g. lamps. Consequently the transparent element has a type of active lighting function. Acoustic devices can also be used, e.g. loudspeakers. Here the transparent element has a public address function. The media consumer can also be an optical device, e.g. a surveillance camera. Heat or temperature sensors can also be used as media consumers. The transparent element can e.g. be a shop window into which is integrated a lighting device with several lights or lamps. This permits an irradiation of the shop window display from the outside, i.e. from the shop window. This has the advantage that the observer is not dazzled. Moreover, with such an irradiation the space available for the goods to be displayed is greater, because the lighting device is not fixed directly in the display surface, as is the case with conventional shop window displays, but instead in the actual shop window. It is also conceivable for the transparent element to be at least part of a glass shop passage, e.g. a glass roof, to which one or more loudspeakers are fitted, so as to allow a public address from above.

Media consumers are understood here to be all devices or means able to modify or convert the supplied medium or an energy state. Thus, it is understood to cover energy converters, signal generators, etc.

It is also possible for the media consumer to be a non-electric consumer or load, e.g. a light guide supplying a media consumer in the form of a light exit and which is positioned in an opening of one of the panes. For example, one or more sprinkler nozzle can be provided as media consumers.

Preferably the media supply takes place in invisible manner. In the case of a current supply the transparent element can be coated with a transparent, electrically conductive and power-transmitting layer. The transparent element is free from any visible media supply lines, which could impair its esthetics.

The layer can be applied in the form of relatively narrow, e.g. a few millimetres wide conducting tracks. It is alternatively possible to have a full-surface coating of the panes, e.g. on the insides directed towards an insulating intermediate layer of the composite pane. Preferably the layer is a transparent, metal-based foil or a metallizing foil. The conducting tracks can be formed by foil strips.

The media supply can also be visible, e.g. using thin wires with a diameter of 0.07 to 0.1 mm, particularly 0.03 to 0.06 mm, which can e.g. be used for the power supply of LEDs.

If two interconnectable, transparent panes are provided, the media supply is located between the panes. The transparent element can e.g. be a composite glass element, in which at least two panes are bonded together by means of a cast resin layer or in particularly preferred manner by a transparent foil or film. The media supply, e.g. in the form of wires, can then be embedded in the intermediate layer or can be in the form of transparent, electrically conducting layers between the intermediate layer and the glass panes. It is alternatively possible to provide a composite safety glass element, in which the at least two panes are interconnected by means of a special foil, a so-called VSG foil. The foil is preferably made from plastic, e.g. polyvinyl butyral (PVB).

The cutout or opening serving as the receptacle for the media consumer, can e.g. be a hole or a recess, in which e.g. in the case of a lighting device a holder-can be inserted, which in turn receives an illuminant. The fixing of the media consumer, e.g. the holder thereof, can take place by means of an adhesive. It is possible to use a two-component adhesive and/or a UV-curing adhesive, or a two-component adhesive with a UV-curing component. In the case of an invisible media supply, the adhesive can also be transparent. It is naturally also possible for the lighting device holder to be transparent. When there are several panes, e.g. a composite glass element, preferably at least one pane has the at least one cutout, whereas at least one further pane is cutout-free and can therefore serve as a contact protection for the media consumer.

An advantage of fitting the consumer or load in or on an opening is its accessibility for replacement or the like. This also provides further use possibilities, e.g. for heat or sound-generating consumers, such as loudspeakers. It can also be advantageous for there to also be an opening in the second pane of the composite element.

There can also be three transparent panes, whereof at least two are outer panes and at least one is a central pane. The media consumer can be fitted in an opening of the central pane. For example, one of the outer panes can be an insulating glass pane, which in turn comprises two pane parts, which are separated from one another by a heat insulating gas layer.

It is also possible in the case of several panes for the individual panes to be detachably interconnected by a clamping system. It is advantageous to provide a rubber seal for sealing the gap between the panes. A replacement of the media consumer is possible if it is located between the panes or is integrated into a central pane. This also makes the media supply accessible for repair purposes.

A building roof element can at least partly comprise a transparent material and form at least one transparent element or can have at least one disk-like, transparent element, e.g. with a lighting device. The transparent element or the roof element can comprise a transparent plastic or glass. On the edge of the transparent element can be provided electric terminals for the current supply of the illuminant using transparent conducting tracks, which are e.g. connected to a power supply device integrated into the roof element holder.

The illuminants can comprise LEDs, which form a dot matrix, so that it is possible to form a moving text display.

If each of the panes carries at least one transparent, full-surface conducting track, it is possible to transmit high currents of above 10 A and consequently also operate a lighting device with low voltage.

If the transparent element is an insulating glass pane, at least one of the glass panes can be a composite glass pane with an insulating plastic layer between the same.

The building roof element can form at least part of a projecting roof or canopy e.g. located in the entrance area of buildings. It is possible to integrate into the canopy building roof element several different types of in particular electric media consumers. For example, there can be a lighting device with at least one light unit, e.g. a halogen light source. Alternatively or additionally there can be a movement signalling device with at least one movement sensor. A surveillance mechanism with at least one surveillance camera can be alternatively or additionally used. It is alternatively possible to form a luminous house number by the provision of LEDs. It is also possible to integrate a conventional, non-luminous house number, e.g. a house number panel and irradiate the same by emitters integrated into the canopy. It is possible to make the power supply leading to the lighting device integrated into the canopy building element invisible, so that a type of “starry sky” is formed, the individual lights appearing to the observer to float in the air quasi-disconnected from their power supply and forming “stars”.

These and further features can be gathered from the claims, description and drawings and the individual features, in each case singly or in the form of subcombination, can be implemented in an embodiment of the invention and in other fields and can represent advantageous, independently protectable constructions. The subdivision of the application into individual sections and the subheadings in no way restricts the general validity of the statements made thereunder.

### BRIEF DESCRIPTION OF THE DRAWINGS

Several embodiments of the invention are described hereinafter relative to the attached drawings, wherein show:

FIG. 1 A diagrammatic representation of a longitudinal section through a transparent element.

FIG. 2 A diagrammatic representation of a longitudinal section through a transparent element in the form of a composite glass pane.

FIG. 3 A diagrammatic plan view of a transparent element with intimated media supply.

FIG. 4 A diagrammatic representation of a longitudinal section trough a transparent element with an insulating glass pane.

FIG. 5 A plan view of a transparent element.

FIG. 5A A plan view of the transparent element according to FIG. 5 with alternative current conduction.

FIG. 6 A diagrammatic representation of a house entrance canopy

FIGS. 7 & 8 Differently equipped canopies according to FIG. 6.

FIG. 9 The roof structure of a conservatory.

FIG. 10 A pedestrian bridge with integrated, illuminated roof elements.

### DESCRIPTION OF PREFERRED EMBODIMENTS

Hereinafter the transparent element 6 is explained relative to a glass element for a building roof. Alternatively the transparent element 6 can comprise transparent plastic, e.g. acrylic glass. The media consumer is chosen in the form of an electric load 7 constituted by a lighting device with an illuminant 14, so that the media supply is a current or power supply.

FIG. 1 shows a transparent element 6 with a pane 20 of single-pane glass, e.g. float glass or polished plate glass. The pane thickness is between 1.5 and 19 mm, in exceptional cases up to 24 mm. The transparent pane 20 has an opening 11, here a through hole or bore serving as a receptacle 15 for the illuminant 14. However, it is also possible to make an offset hole, where a larger hole is followed by a smaller diameter hole, which in turn serves as a receptacle 5 for the power supply 9 in the form of a cable or wire 15. Into the hole 11 is bonded a holder 13 into which is screwed the illuminant 14. An adhesive, e.g. a UV-curing adhesive is used for bonding purposes. The holder 13 is connected to a power supply 9 in the form of a cable 15. The cable 15 can be a flat cable, e.g. for halogen light source, or a relatively thin wire with a diameter of approximately 0.05 mm for an illuminant 14 in the form of a LED. The cable 15 runs preferably on the side of the transparent pane 20 opposite to the illuminant 14 to the level of hole 11 and then through the latter to the holder 13. The opening 11 and back of the pane 20 are covered with a layer 23, which can e.g. comprise a plastic layer, film or disk and is bonded to the pane. It can also be provided with a slot for receiving the cable 15.

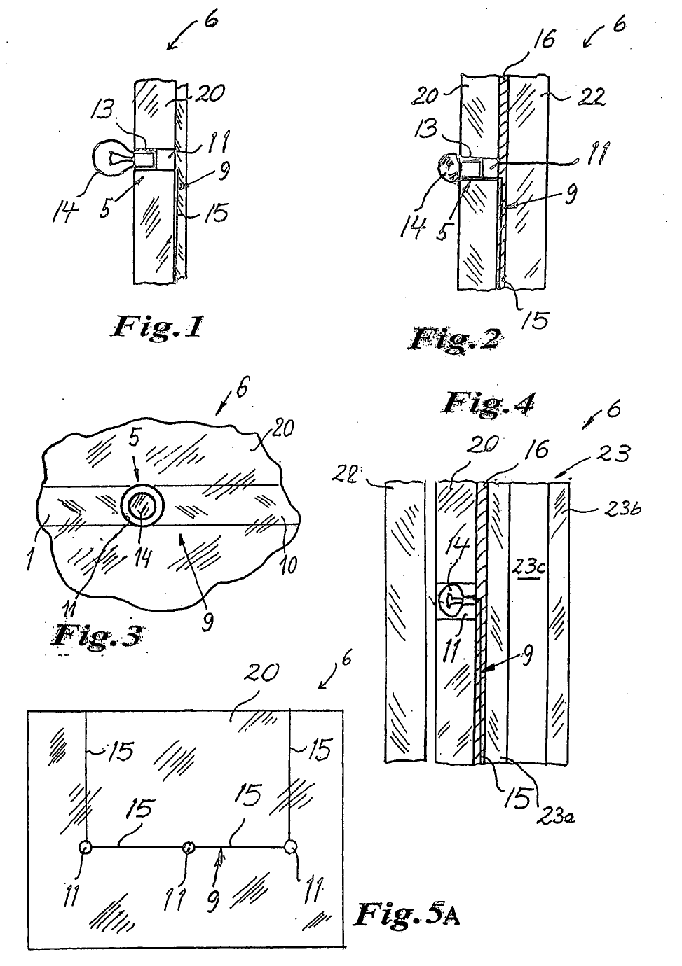

In place of the cable 15 the power supply can be constituted by a transparent, electrically conducting and power-transmitting layer. The layer can be a metal-based foil applied in the form of foil strips constituting conducting tracks 10, 12 12 (FIG. 3) to the outside of the transparent pane 20. The application of a transparent layer offers the advantage that the power supply 9 is not visible and consequently does not prejudice the overall impression of the transparent element 6

FIG. 2 shows as the transparent element 6 a composite glass element comprising two glass panes 20, 22. The two panes 20, 22 are bonded together by means of a connecting layer 16. The connecting layer 16 can be a cast resin layer or in the case of a composite safety glass one or more elastic, high tensile strength plastic films, so-called VSG films. Polyvinyl butyral (PVB) can e.g. be used as the plastic. The fixing of the illuminant 14 in the form of a light emitting diode, together with the holder 13, can take place in the manner described relative to FIG. 1. Fixing in the area around the opening 11 is also possible. Current-supplying wires 15 are embedded in the connecting layer 16. It is also possible here to fit a transparent layer covered in insulating manner by the connecting layer 16.

FIG. 3 is a plan view of element 6 according to FIG. 2. The current supply 7 in the form of electrically conducting, transparent, strip-like layers applied to the pane 20 on the surface facing the connecting layer leads from both sides to the illuminant 14 and is contacted with the latter. In the case of several illuminants on one disk, they can be connected in series or in parallel.

FIG. 4 shows a transparent element 6 with two transparent panes 20, 23 bonded together by means of a connecting layer 16. One of the two panes is an insulating glass pane 23. The insulating glass pane 23 in turn has two insulating glass pane parts 23a, 23b separated from one another by a gas-filled gap 23c, the gas acting as thermal insulation. The gas can be air or an inert gas, e.g. argon, krypton or xenon, gas mixtures also being possible. The distance between the two insulating glass pane parts 23a, 23b is 5 to 25 mm. The pane 20 has a hole 11 for receiving an illuminant. The illuminant 14 is completely integrated into the hole 11. The current supply can take place in accordance with FIGS. 2 and 3. Without impeding accessibility to the consumer or load 14, an additional pane 22 can be placed using a clamping system in front of pane 20. This also permits repairs to the current supply, e.g. if there is a loose connection or a cable is damaged.

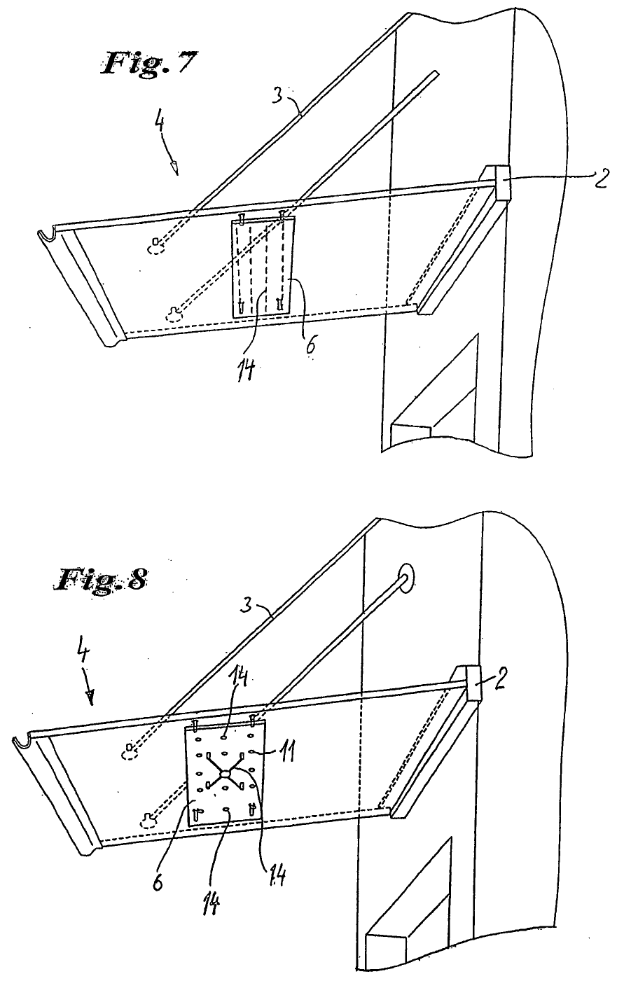

FIG. 6 shows a transparent element 6, in which the current-conducting cables 15 are deliberately visible. The visible cables 15 run much as in the embodiment of FIG. 2 in the connecting layer 16 between the panes 20, 22 up to the level of holes 11 and pass through the latter, so that they can be connected to the load 7. There are also further holes 28 used for fixing the transparent element, e.g. as a canopy glass element with the aid of supports or rods. As a function of their use, the holes 28 can be randomly positioned.

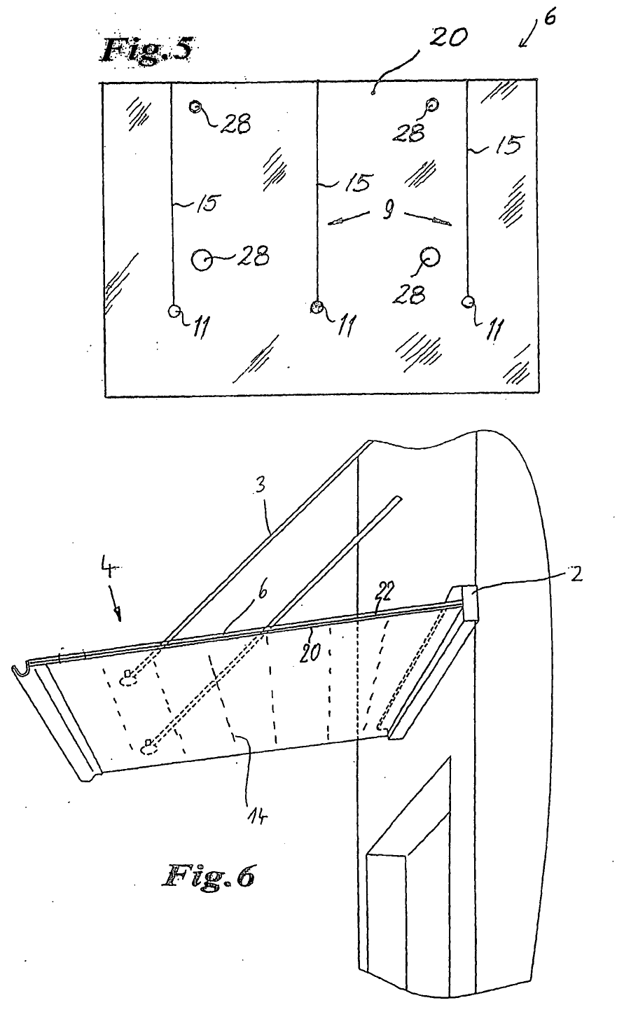

FIG. 5a shows the transparent element of FIG. 5 with the power supply 7 in series connection.

FIG. 6 shows a house facade to which is fixed a transparent element 6 in the form of a projecting roof or canopy 4 using a holder 2. The holder 2 can be supported by holding rod 3 or cables in order to permit higher roof loads.

On the side of the roof element 4 facing the holder 2, two line terminals pass out of the faces of the roof element 4 and are connected to at least two conducting tracks integrated into the roof element 4 applied by coating to the panes 20, 22 of the transparent element 6. The transparent conducting tracks make it possible to transmit current intensities of more than 10 a and up to approximately 20 A to a lighting device 14. The coating of the glass with a transparent, electrically conducting layer is fundamentally known from WO 99/03111. The conducting tracks 10, 12 can be applied in accordance with a specific pattern to the transparent element 6 in order to permit the power supply of the lighting device illuminant 14.

Preferably the roof element 4 or transparent element 6 is made from a composite glass constituted by two glass panes and an intermediate insulating plastic layer and then the conducting tracks 10, 12 can be applied in full-surface manner to in each case one of the glass panes.

The openings of the lower pane 20 having the illuminants 14, are directed downwards and are consequently protected against atmospheric influences. The illuminant 14 could be located on a random side of the roof element and contact both conducting tracks 10, 12 in order to be supplied with power. Current-supplying elements are then visible at no point on the roof element 4.

In the case of an insulating glass pane 23 the illuminants 14 can also be placed in the cavity between the panes of the insulating glass pane 23.

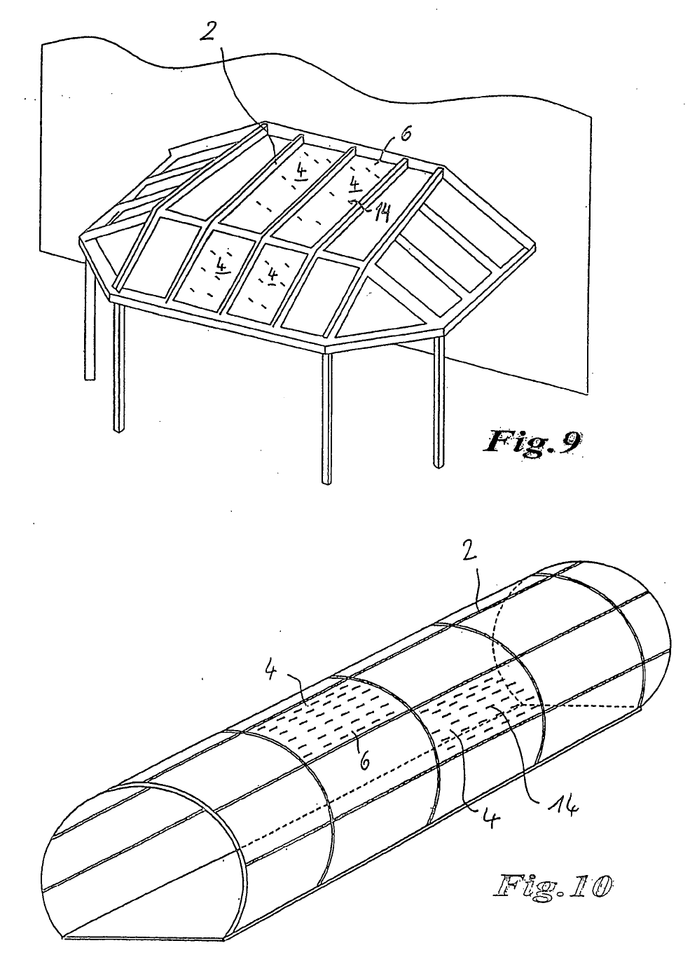

FIG. 7 shows an alternative embodiment to FIG. 6, in which the illuminants 14 are located in a disk-like, transparent element 6 fixed to the roof element 4.

In this case the roof element 4 can itself be made from transparent or non-transparent material and only the disk-like element 6 is transparent. Power is then supplied in invisible manner via fixing elements of the transparent element 8 and the transparent conducting tracks 10, 12 are then provided in the transparent element 6 and can also additionally be provided in the roof element 4.

FIG. 8 is similar to FIG. 7. In the disk-like, transparent element are provided several LEDs 14, which are integrated into the element 8 preferably comprising a glass pane. Additional illuminants 14 can be fixed to the underside of the transparent element 8 and are invisibly supplied with power through openings 11.

FIG. 9 shows the integration of roof elements 4 into a conservatory making it possible to provide in said conservatory an illuminated roof surface without disturbing visible power supply means and without separate lighting devices on the conservatory supports.

FIG. 10 shows a further use in the case of pedestrian bridges, such as are known on fair terrains, also for linking two buildings.

In all embodiments and in particular in the case of roof elements 4 in pedestrian bridges, the lighting device can also be placed on the roof elements 4 in such a way that they form with the aid of LEDs 14 a dot matrix displaying information. It is e.g. possible to display advertisements or other information in computer-controlled manner using moving text displays via LEDs 14 on the roof element surfaces.

1. Transparent element, particularly composite glass element, which has at least one transparent pane (20, 22), the transparent element (6) having at least one receptacle (5) for at least one media consumer (7) and the media supply (9) for supplying the media consumer (7) is integrated into the transparent element (6).

2. Transparent element according to claim 1, characterized in that it has two glass panes (20, 22), whereof one pane (20) has as the receptacle (5) an opening, that in or on the opening (11) is provided the media consumer (7), that between both panes (20, 22) is provided a gap (16), preferably filled with an insulating, transparent material and optionally interconnecting the panes and in said gap runs the media supply (9) supplying the media consumer (7) through the opening (11).

3. Transparent element according to claim 1, characterized in that the media consumer (7) is an electric load or energy converter and the media supply (9) is a current or power supply.

4. Transparent element according to claim 1, characterized in that the media supply (9) is a light guide supplying the media consumer.

5. Transparent element according to claim 1, characterized in that the media supply takes place in invisible manner, particularly by means of a coating of at least one of the panes (20, 22) with at least one transparent, preferably electrically conducting and power-transmitting layer, the layer optionally being in the form of narrow conducting tracks (10, 12).

6. Transparent element according to claim 5, characterized in that the layer is a transparent, metal-based foil and preferably the conducting tracks (10, 12) are formed by foil strips.

7. Transparent element according to claim 1, characterized in that the pane (20) broken by the receptacle (5) is adhesively connected flat to at least one further pane (22) by means of a foil (16), the connection preferably taking place by heating under pressure.

8. Transparent element according to claim 7, characterized in that the panes (20, 22) and optionally a further covering pane (23) for the pane (20) provided with the openings (11) are detachably interconnected by a clamping system.

9. Transparent element according to claim 8, characterized in that in the case of several panes (20, 22, 23), at least one pane (20) has the opening (11) and at least one further cutout-free pane (23) serves as a contact protection.

10. Transparent element according to claim 1, characterized in that it is a building roof or canopy element.
